(19) United States
(12) Patent Application Publication
(10) Pub. No.: US 2012/0280890 A1
(43) Pub. Date: Nov. 8, 2012

(54) ANTENNA AND WIRELESS COMMUNICATION DEVICE

(75) Inventor: Yusuke KUSUMOTO, Kyoto-fu (JP)

(73) Assignee: MURATA MANUFACTURING CO., LTD., Kyoto-fu (JP)

(21) Appl. No.: 13/550,199

(22) Filed: Jul. 16, 2012

Related U.S. Application Data
(63) Continuation-in-part of application No. PCT/JP2010/063071, filed on Aug. 3, 2010.

(30) Foreign Application Priority Data
Jan. 18, 2010 (JP) 2010-007932

(51) Int. Cl. H01Q 1/50

(52) U.S. Cl. 343/906

(57) ABSTRACT

An antenna having a high design freedom, a wide bandwidth characteristic, and a high efficiency characteristic, and a wireless communication device equipped therewith, are provided. The antenna includes at least first and second radiation electrodes and a feeding electrode that faces each of the radiation electrodes such that capacitance occurs between each of the radiation electrodes and the feeding electrode. Each of the radiation electrodes includes a first end portion thereof connected to a ground electrode and a second end portion open, and is capacitively fed by the feeding electrode.

### CROSS REFERENCE TO RELATED APPLICATIONS

The present application claims priority to International Application No. PCT/JP2010/063071 filed on Aug. 3, 2010, and to Japanese Patent Application No. 2010-007932 filed on Jan. 18, 2010, the entire contents of each of these applications being incorporated herein by reference in their entirety.

### TECHNICAL FIELD

The technical field relates to an antenna used for a wireless communication device such as a mobile phone terminal and a wireless communication device equipped therewith.

### BACKGROUND

An antenna device incorporated in a wireless communication device such as a mobile phone terminal has a multiband capability and a compact size. As antenna devices having multiband capabilities, Japanese Unexamined Patent Application Publication No. 5-90828 (Patent Document 1), Japanese Unexamined Patent Application Publication No. 2005-150937 (Patent Document 2), and Japanese Unexamined Patent Application Publication No. 8-330830 (Patent Document 3) have been disclosed.

In Patent Document 1, an antenna is disclosed that has a structure where a passive element, one end of which is grounded, and a radiation element are vertically laminated and disposed.

In Patent Document 2, an antenna is disclosed that includes a power feeding radiation electrode which has a plurality of resonance frequencies different from one another and in which one end side thereof serves as a power feeding end portion and the other end side thereof serves as an open end portion.

In Patent Document 3, a surface mount type antenna is disclosed where a radiation electrode, one end of which is connected to a ground electrode and the other end of which is open, a power feeding electrode, and a coupling electrode are laminated and integrally formed within a dielectric, and the radiation electrode and the power feeding electrode are electromagnetic-field coupled to each other through capacitance formed between the radiation electrode and the coupling electrode.

FIG. 1 is a diagram illustrating the configuration of an antenna device of Patent Document 1. In the antenna device of Patent Document 1, a power-fed plate-like radiation conductive element 2 and a passive added conductor plate 3 are laminated in the upper portion of a grounded conductor plate 1. A short-circuit conductive element 6 and a short circuit conductor plate 7, which are connected to the grounded conductor plate 1, are separately formed in one end of the plate-like radiation conductive element 2 and one end of the added conductor plate 3, respectively, where the ends are located on a same side. A positioning mechanism is provided that allows a relative position between one end of the plate-like radiation conductive element 2, short-circuited to the grounded conductor plate 1, and one end of the added conductor plate 3, short-circuited to the grounded conductor plate 1, to be variable, and hence, it is possible to vary an electromagnetic field coupling amount between the plate-like radiation conductive element 2 and the added conductor plate 3. Owing to the resonance of ¼ wavelength of the plate-like radiation conductive element 2 and the added conductor plate 3, disposed so as to face the plate-like radiation conductive element 2 and power-fed owing to electromagnetic field coupling, the antenna is double-resonated (two-resonated).

### SUMMARY

The present disclosure provides an antenna having a high design freedom, a wide bandwidth characteristic, and a high efficiency characteristic and a wireless communication device equipped therewith.

In one aspect of the present disclosure, an antenna is a capacitive feed type antenna including plural radiation electrodes, where each radiation electrode includes a first end portion thereof connected to a ground electrode and a second end portion thereof open, and a single feeding electrode having a first end portion thereof connected to a feeder circuit. The feeding electrode faces each of the radiation electrodes, thereby causing capacitance to occur between the feeding electrode and each of the radiation electrodes. Each radiation electrode is capacitively fed by the feeding electrode in a capacitive feeding portion.

In another aspect of the disclosure, a wireless communication device includes the above antenna and is provided in a chassis.

### BRIEF DESCRIPTION OF DRAWINGS

FIG. 1 is a diagram illustrating a configuration of an antenna device of Patent Document 1.

FIG. 2 is a perspective view illustrating a configuration of a main portion of an antenna 201 provided within a chassis of a wireless communication device such as a mobile phone terminal.

FIG. 3 is a perspective view of an antenna chip 101 serving as one element of the antenna 201.

FIG. 4A is a diagram illustrating a path of a current flowing through a radiation electrode of the antenna 201. FIG. 4B is a diagram illustrating an intensity distribution of the current.

FIG. 5 is an equivalent circuit of the antenna 201.

FIG. 6 is a perspective view illustrating a configuration of a main portion of an antenna 202.

FIG. 7 is a perspective view of an antenna chip 102 serving as one element of the antenna 202.

FIG. 8A is a frequency characteristic diagram of a return loss of the antenna 202. FIG. 8B is a diagram where an impedance locus of an antenna is expressed on a Smith chart.

FIG. 9 is a perspective view illustrating a configuration of a main portion of an antenna 203.

FIG. 10 is a perspective view of an antenna chip 103 serving as one element of the antenna 203.

FIG. 11 is a perspective view illustrating a configuration of a main portion of an antenna 204 according to a fourth embodiment.

FIG. 12A is a perspective view where a main portion of an antenna 205 is looked down from above, and FIG. 12B is a perspective view where the main portion of the antenna 205 is looked up from below.

FIG. 13 is a perspective view of an antenna chip 105 serving as one element of the antenna 205.

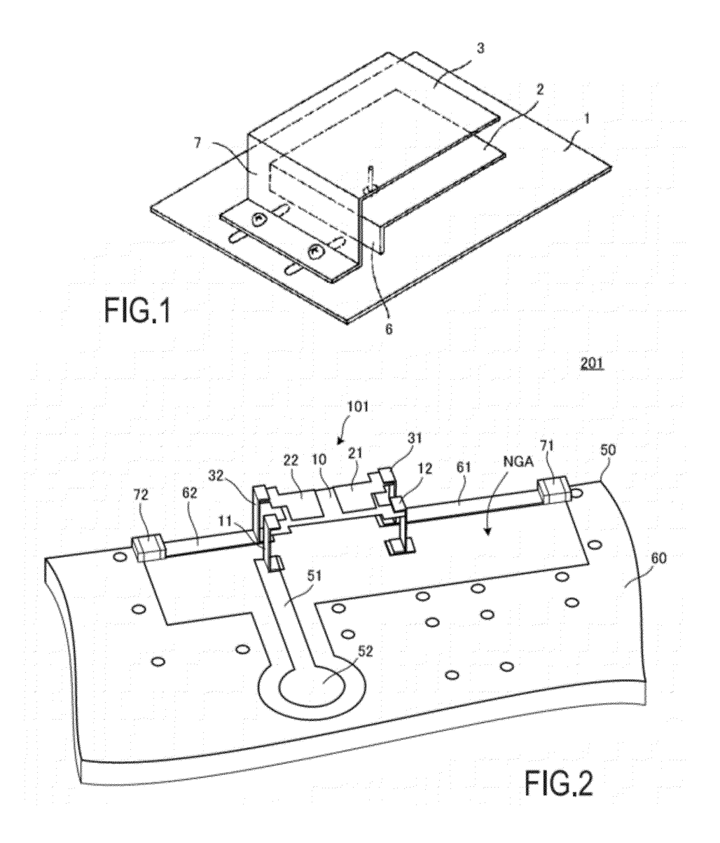

### DETAILED DESCRIPTION

The inventor realized that with the antenna disclosed in Patent Document 1 realizes double-resonating (two-resonating) using resonance due to a directly power-fed electrode and resonance due to an electrode power-fed owing to electromagnetic field coupling, when a plate-like radiation conductive element length changes, since a capacitance value with respect to the added conductor plate power-fed owing to electromagnetic field coupling changes, it is difficult to control each frequency independently.

The content of the antenna disclosed in Patent Document 2 relates to a technique for switching a resonance frequency. The inventor recognized that and the antenna has a disadvantage that since an electrode (electrostatic capacitance adding portion) connected to ground through a matching element is put close to the open end portion of a feeding electrode, antenna efficiency is deteriorated.

The antenna disclosed in Patent Document 3 has a structure where one radiation electrode is included between two coupling electrodes connected to a power feeding electrode, thereby realizing a wider bandwidth. It is described that a plurality of radiation electrodes are formed in different dielectric sheets and hence a plurality of resonance frequencies are attached. However, the inventor realized that since a terminal linked to the radiation electrode is a common terminal, there is a disadvantage that individual currents interfere with each other and antenna efficiency is deteriorated.

In view of the above drawbacks, the present disclosure provides an antenna and a wireless communication device including such an antenna, where the antenna can have a high design freedom, a wide bandwidth characteristic, and a high efficiency characteristic.

An antenna according to a first exemplary embodiment and a wireless communication device equipped therewith will now be described with reference to FIG. 2 to FIG. 5.

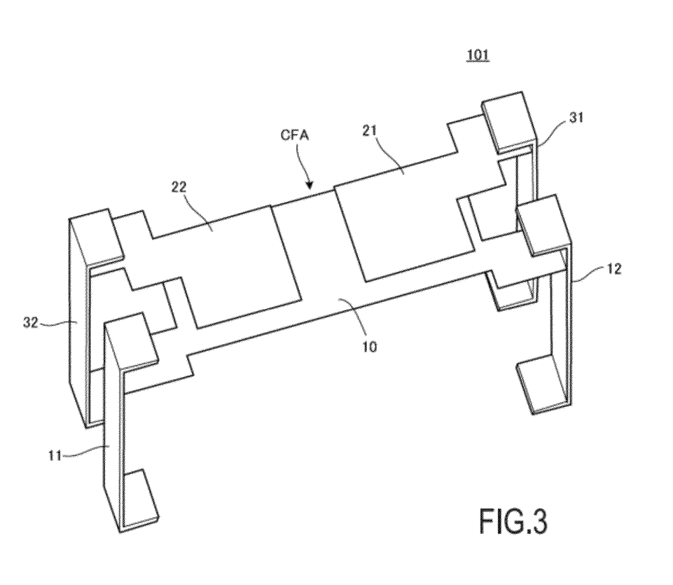

FIG. 2 is a perspective view illustrating the configuration of the main portion of an antenna 201 provided within the chassis of a wireless communication device such as a mobile phone terminal. FIG. 3 is the perspective view of an antenna chip 101 serving as one element of the antenna 201. In this regard, however, a dielectric portion of the antenna chip 101 is not illustrated, and the dielectric portion is drawn so as to be transparent.

The antenna 201 includes a circuit substrate 50 and an antenna chip 101 mounted on the circuit substrate 50. As illustrated in FIG. 3, in the antenna chip 101, a plurality of dielectric layers and a plurality of electrode layers are laminated to be formed in a rectangular parallelepiped shape, and a plurality of terminal electrodes are formed from both end surfaces to top and bottom surfaces. A first radiation electrode 21 and a second radiation electrode 22 are formed on an upper layer. A feeding electrode 10 is formed on a lower layer. A dielectric layer (not shown) is provided between the first radiation electrode 21 and second radiation electrode 22 and the feeding electrode 10. Accordingly, a portion where the first radiation electrode 21 and the feeding electrode 10 face each other create a capacitance, and a portion where the second radiation electrode 22 and the feeding electrode 10 face each other create a capacitance. These capacitive portions function as a capacitive feeding portion CFA.

One end of the first radiation electrode 21 is conductively connected to a ground connection terminal 31. One end of the second radiation electrode 22 is conductively connected to a ground connection terminal 32. In this regard, however, as illustrated later, in the first exemplary embodiment, the ground connection terminals 31 and 32 are not directly connected to the ground electrode of a circuit substrate, and are connected to a radiation electrode on the circuit substrate.

The first end portion of the feeding electrode 10 is conductively connected to a power feeding terminal 11, and the second end portion thereof is conductively connected to a power feeding terminal 12. In this regard, however, as illustrated later, the power feeding terminal 12 is used as a dummy terminal connected to a land independent in an island shape on the circuit substrate.

As illustrated in FIG. 2, in the top surface of the circuit substrate 50, a ground electrode 60 is formed that spreads in a sheet shape. In the vicinity of one side of the circuit substrate 50, a rectangle-shaped non-ground region NGA is formed. Along one side of the non-ground region NGA, a first substrate-side radiation electrode 61 and a second substrate-side radiation electrode 62 are formed. The circuit substrate 50 is provided within the chassis so that the non-ground region NGA is disposed in the vicinity of an end portion within the chassis of the wireless communication device.

In the bottom surface of the circuit substrate 50, a ground electrode and a non-ground region are formed whose patterns are the same as the ground electrode 60 and the non-ground region NGA in the top surface. Namely, the ground electrode and the non-ground region are also formed in the bottom surface of the circuit substrate 50 so that the ground electrodes in the top and bottom surfaces face each other and the non-ground regions in the top and bottom surfaces face each other.

Within the non-ground region NGA in the top surface of the circuit substrate 50, a power feeding line 51 and a substrate-side power feeding terminal 52 are formed. A feeder circuit not illustrated in the drawing is connected to the substrate-side power feeding terminal 52.

The antenna chip 101 is mounted in the non-ground region NGA. In this state, the ground connection terminal 31 is conductively connected to an end portion on the inner side of the first substrate-side radiation electrode 61, and the ground connection terminal 32 is conductively connected to an end portion on the inner side of the second substrate-side radiation electrode 62. In addition, the power feeding terminal 11 is conductively connected to the power feeding line 51. The power feeding terminal 12 is connected to a land independent and in an island shape within the non-ground region NGA.

A frequency adjusting element 71 is mounted between an end portion on the outer side of the first substrate-side radiation electrode 61 and the ground electrode 60. In the same way, a frequency adjusting element 72 is mounted between an end portion on the outer side of the second substrate-side radiation electrode 62 and the ground electrode 60. The frequency adjusting elements 71 and 72 are reactance elements such as chip inductors or chip capacitors. By connecting such a reactance element between the radiation electrode and the ground electrode, it is possible to change the reactance component or the effective length of the radiation electrode, and hence, it is possible to adjust a resonance frequency. In this regard, however, these frequency adjusting elements 71 and 72 are not required, and the first substrate-side radiation electrode 61 may also be continuous with the ground electrode 60. In addition, only one of the frequency adjusting elements 71 and 72 may be provided. In the same way, this is applied to the other subsequent embodiments.

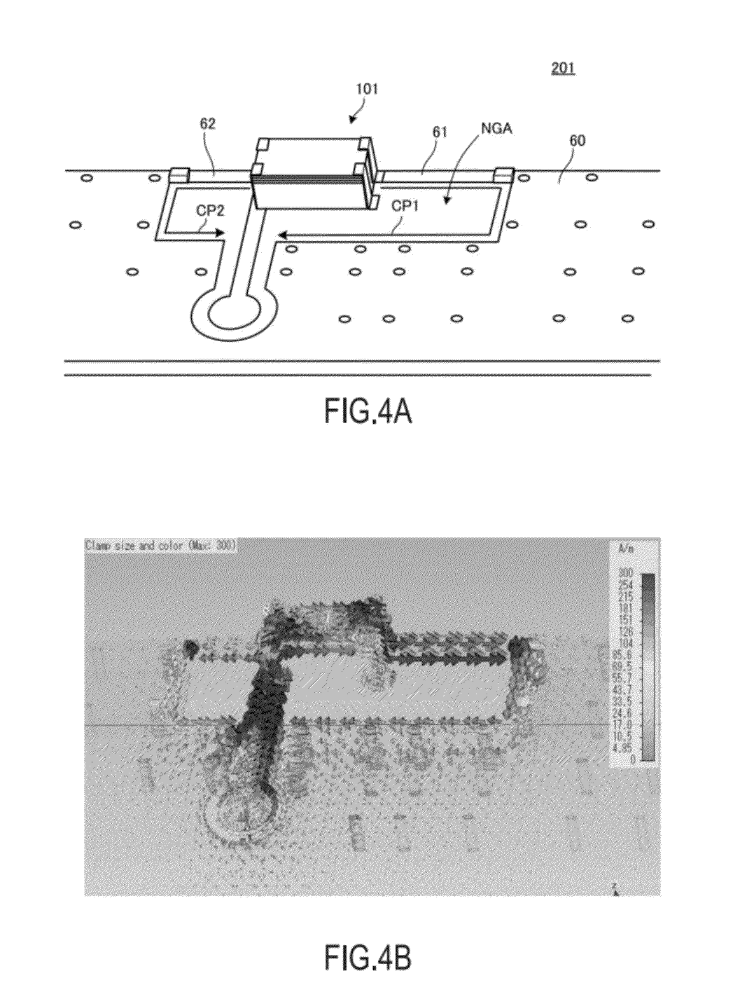

FIG. 4A is a diagram illustrating the path of a current flowing through the radiation electrode of the antenna 201. FIG. 4B is a diagram illustrating the intensity distribution of the current. In FIG. 4A, an actual external appearance is expressed while the dielectric of the antenna chip 101 is shown (i.e., not caused to be transparent). As illustrated in FIG. 4A, actual currents flow through the path of the first radiation electrode 21 (see FIG. 2) of the antenna chip 101→the first substrate-side radiation electrode 61→the ground electrode 60 and the path of the second radiation electrode 22 (see FIG. 2) of the antenna chip 101→the second substrate-side radiation electrode 62→the ground electrode 60, respectively. The currents not only flow through the substrate-side radiation electrodes 61 and 62 but also flow along the periphery of the non-ground region NGA in the ground electrode 60 (the end edge of the ground electrode). Accordingly, the ground electrode in the periphery of the non-ground region NGA also contributes to radiation. Therefore, the resonance frequency of the antenna also changes owing to the length of the periphery of the non-ground region NGA (the end edge of the ground electrode 60).

FIG. 5 is the equivalent circuit of the antenna 201. Owing to the first radiation electrode 21 and the first substrate-side radiation electrode 61, a function as the first radiation electrode that is one-end-grounded and one-end-open is realized. In addition, owing to the second radiation electrode 22 and the second substrate-side radiation electrode 62, a function as the second radiation electrode that is one-end-grounded and one-end-open is realized. The vicinities of the open ends of the two radiation electrodes 21, 22 face the feeding electrode 10, and capacitances individually occur between the two radiation electrodes and the feeding electrode 10. In this way, the two independent radiation electrodes are capacitively fed.

The resonance frequency of the antenna, due to the first radiation electrode including the first radiation electrode 21 and the first substrate-side radiation electrode 61, is defined on the basis of the length of the radiation electrode and the capacitance of the open end. Namely, the resonance frequency of the antenna is defined on the basis of the length of the first radiation electrode 21, the length of the first substrate-side radiation electrode 61, the reactance of the frequency adjusting element 71, the length of the periphery of the non-ground region NGA (the end edge of the ground electrode 60), the relative permittivity of the dielectric portion of the antenna chip 101, and a facing area and a facing gap between the first radiation electrode 21 and the feeding electrode 10. In the same way, the resonance frequency of the antenna, due to the second radiation electrode including the second radiation electrode 22 and the second substrate-side radiation electrode 62, is defined on the basis of the length of the second radiation electrode 22, the length of the second substrate-side radiation electrode 62, the reactance of the frequency adjusting element 72, the length of the periphery of the non-ground region (the end edge of the ground electrode 60), the relative permittivity of the dielectric portion of the antenna chip 102, and a facing area and a facing gap between the second radiation electrode 22 and the feeding electrode 10.

Even if the configuration of the circuit substrate 50 is the same, it is also possible to define the two resonance frequencies by selecting different capacitances occurring between the radiation electrodes 21 and 22 and the feeding electrode 10 in the antenna chip 101.

In addition, even if the lengths of the first substrate-side radiation electrode 61 and the second substrate-side radiation electrode 62 are equal to each other, it is possible to define each of the resonance frequencies of “two-resonance” by setting the lengths of the first radiation electrode 21 and the second radiation electrode 22 in the antenna chip to lengths different from each other or by setting capacitances, which occur between the vicinities of the open ends of the first radiation electrode 21 and the second radiation electrode 22 and the feeding electrode, to values different from each other.

In addition, even if the lengths of the first radiation electrode 21 and the second radiation electrode 22 in the antenna chip 101 are equal to each other and the capacitances, which occur between the vicinities of the open ends of the first radiation electrode 21 and the second radiation electrode 22 and the feeding electrode, are equal to each other, it is possible to define each of the resonance frequencies of “two-resonance” by causing the lengths of the first substrate-side radiation electrode 61 and the second substrate-side radiation electrode 62 to be different from each other.

According to the first exemplary embodiment, the connection ends of two radiation electrodes, connected to a ground electrode, are independent of each other, and hence, it is possible to freely dispose independent lines connected from the two radiation electrodes to the ground electrode. In addition, since the directions of the current paths (the directions of currents) connected from the capacitive feeding portion CFA to the ground electrode are caused to be opposite to each other (in an inverse direction by 180 degrees), the two current paths are kept away from each other, and hence, it is possible to prevent the antenna efficiency from being deteriorated owing to the flow of a current of a reverse phase.

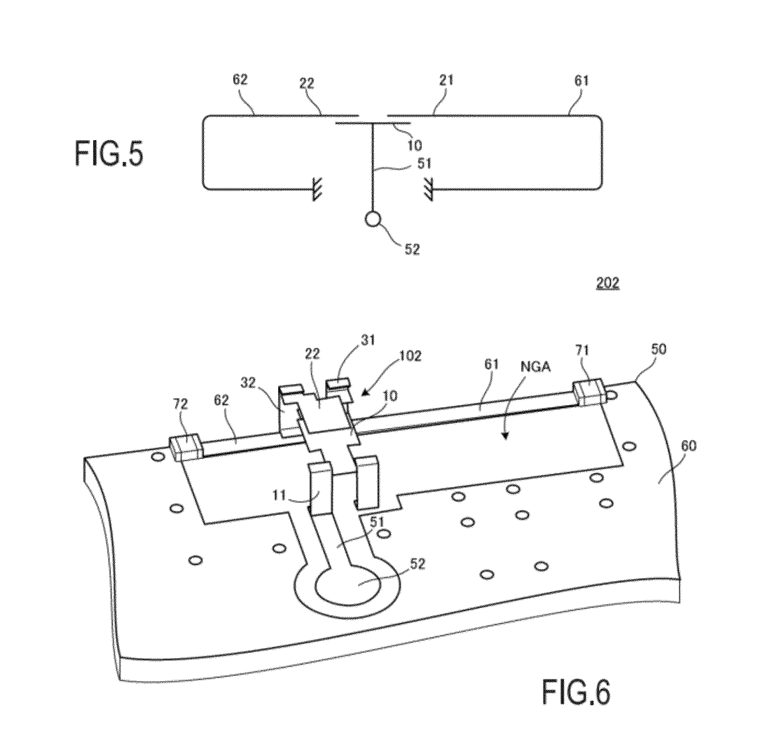

An antenna according to a second exemplary embodiment and a wireless communication device equipped therewith will now be described with reference to FIG. 6 to FIG. 8.

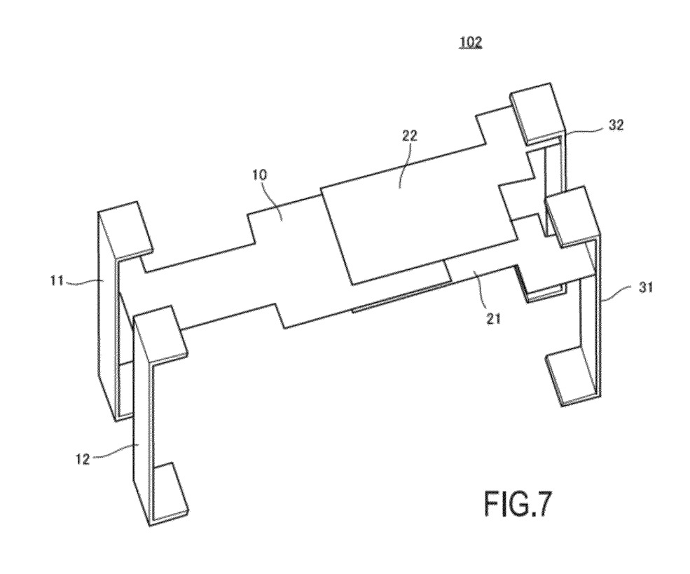

FIG. 6 is a perspective view illustrating the configuration of the main portion of an antenna 202. FIG. 7 is the perspective view of an antenna chip 102 serving as one element of the antenna 202. In this regard, however, the dielectric portion of the antenna chip 102 is not illustrated, and the dielectric portion is drawn so as to be transparent.

The antenna 202 includes a circuit substrate 50 and the antenna chip 102 mounted in the circuit substrate 50.

As illustrated in FIG. 7, in the antenna chip 102, a plurality of dielectric layers and a plurality of electrode layers are laminated to be formed in a rectangular parallelepiped shape, and a plurality of terminal electrodes are formed from both end surfaces to top and bottom surfaces. A first radiation electrode 21 is formed in a lower layer. A second radiation electrode 22 is formed in an upper layer. A feeding electrode 10 is formed in an intermediate layer. Dielectric layers (not shown) are provided between the first radiation electrode 21 and the feeding electrode 10 and between the second radiation electrode 22 and the feeding electrode 10, respectively. Accordingly, capacitances occur between the first radiation electrode 21 and the feeding electrode 10 and between the second radiation electrode 22 and the feeding electrode 10, respectively.

One end of the first radiation electrode 21 is conductively connected to a ground connection terminal 31. One end of the second radiation electrode 22 is conductively connected to a ground connection terminal 32. The first end portion of the feeding electrode 10 is conductively connected to a power feeding terminal 11, and the second end portion thereof is conductively connected to a power feeding terminal 12. In this regard, however, as illustrated later, the power feeding terminal 12 is used as a dummy terminal connected to a land independent and in an island shape on the circuit substrate.

As illustrated in FIG. 6, in the top surface of the circuit substrate 50, a ground electrode 60 is formed that spreads in a sheet shape. In the vicinity of one side of the circuit substrate 50, a rectangle-shaped non-ground region NGA is formed. Along one side of the non-ground region NGA, a first substrate-side radiation electrode 61 and a second substrate-side radiation electrode 62 are formed.

In the bottom surface of the circuit substrate 50, a ground electrode and a non-ground region are formed whose patterns are the same as the ground electrode 60 and the non-ground region NGA in the top surface. Namely, the ground electrode and the non-ground region are also formed in the bottom surface of the circuit substrate 50 so that the ground electrodes in the top and bottom surfaces face each other and the non-ground regions in the top and bottom surfaces face each other.

Within the non-ground region NGA in the top surface of the circuit substrate 50, a power feeding line 51 and a substrate-side power feeding terminal 52 are formed.

The antenna chip 102 is mounted in the non-ground region NGA. In this state, the ground connection terminal 31 is conductively connected to an end portion on the inner side of the first substrate-side radiation electrode 61, and the ground connection terminal 32 is conductively connected to an end portion on the inner side of the second substrate-side radiation electrode 62. In addition, the power feeding terminal 11 is conductively connected to the power feeding line 51. The power feeding terminal 12 is connected to the land independent and in an island shape within the non-ground region NGA.

A frequency adjusting element 71 is mounted between an end portion on the outer side of the first substrate-side radiation electrode 61 and the ground electrode 60. In the same way, a frequency adjusting element 72 is mounted between an end portion on the outer side of the second substrate-side radiation electrode 62 and the ground electrode 60.

In the same way as in the antenna 201 illustrated in the first exemplary embodiment, actual currents flow through the path of the first radiation electrode 21 of the antenna chip 102→the first substrate-side radiation electrode 61→the ground electrode 60 and the path of the second radiation electrode 22 of the antenna chip 102→the second substrate-side radiation electrode 62→the ground electrode 60, respectively.

The equivalent circuit of the antenna 202 is the same as that illustrated in FIG. 5 in the first exemplary embodiment.

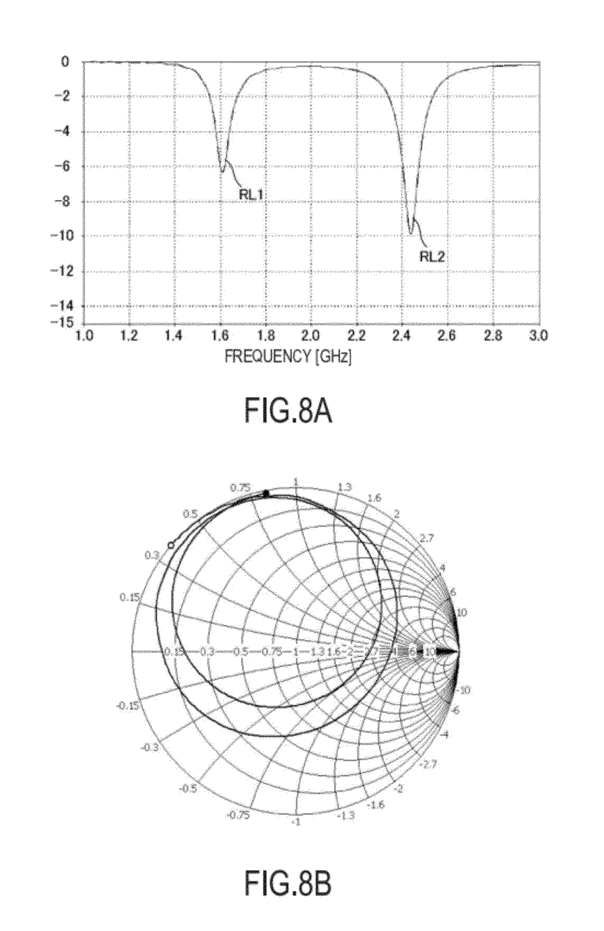

FIG. 8A is the frequency characteristic diagram of the return loss of the antenna 202. A return loss RL1 due to the first radiation electrode including the first radiation electrode 21 and the first substrate-side radiation electrode 61 occurs in a GPS band (about 1.6 GHz). In addition, a return loss RL2 due to the second radiation electrode including the second radiation electrode 22 and the second substrate-side radiation electrode 62 occurs in BT (Bluetooth band: about 2.40 GHz to 2.48 GHz).

FIG. 8B is a diagram where the impedance locus of an antenna is expressed on a Smith chart.

These results are results obtained by performing simulation in a Micro wave studio. Here, it is assumed that the outside dimension of the antenna chip 102 roughly corresponds to a length of 3.2 mm×a width of 1.6 mm×a height of 1.2 mm and the relative permittivity of a dielectric is about 8 to 9. It is assumed that a facing area between the second radiation electrode 22 and the feeding electrode 10 is 0.8 mm×1.1 mm and a facing gap therebetween is 0.1 mm. In addition, it is assumed that a facing area between the first radiation electrode 21 and the feeding electrode 10 is 0.5 mm×1.1 mm and a facing gap therebetween is 0.1 mm.

In the second exemplary embodiment, the same advantageous effect as the first embodiment is also achieved.

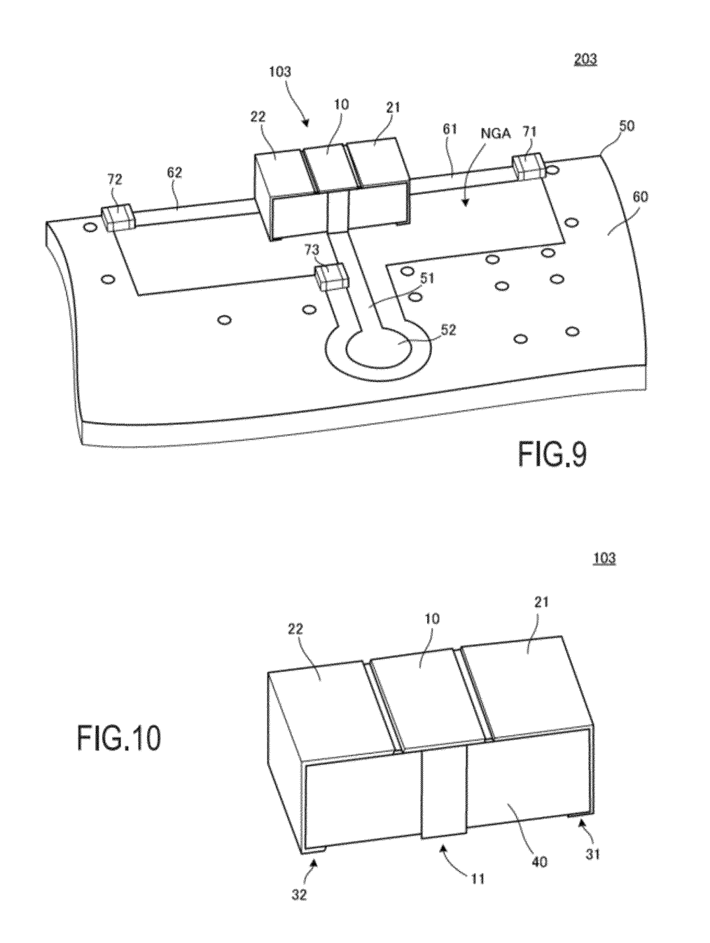

An antenna according to a third exemplary embodiment and a wireless communication device equipped therewith will be described with reference to FIG. 9 and FIG. 10.

FIG. 9 is a perspective view illustrating the configuration of the main portion of an antenna 203. FIG. 10 is the perspective view of an antenna chip 103 serving as one element of the antenna 203.

The antenna 203 includes a circuit substrate 50 and the antenna chip 103 mounted in the circuit substrate 50.

As illustrated in FIG. 10, in the antenna chip 103, various kinds of electrodes are formed in the outer surface of a dielectric block 40. A first radiation electrode 21 and a feeding electrode 10 are formed so that the first radiation electrode 21 and the feeding electrode 10 face each other with a predetermined gap therebetween in the top surface of the dielectric block 40. In addition, a second radiation electrode 22 is formed so that the second radiation electrode 22 and the feeding electrode 10 face each other with a predetermined gap therebetween. In the bottom surface of the dielectric block 40, ground connection terminals 31 and 32 and a power feeding terminal 11 are formed. The first radiation electrode 21 is conductively connected to the ground connection terminal 31 in the bottom surface through one end surface of the dielectric block 40. The second radiation electrode 22 is conductively connected to the ground connection terminal 32 in the bottom surface through the other end surface of the dielectric block 40. In addition, the feeding electrode 10 is conductively connected to the power feeding terminal 11 in the bottom surface through one side surface of the dielectric block 40.

Owing to this structure, capacitance occurs between the first radiation electrode 21 and the feeding electrode 10, and capacitance occurs between the second radiation electrode 22 and the feeding electrode 10. Since the open ends of the first radiation electrode 21 and the second radiation electrode 22 are located away from each other and sandwich the feeding electrode 10 therebetween, and the ground connection terminals 31 and 32 are also disposed to be located away from each other, no unnecessary coupling and no unnecessary interference occur between the two radiation electrodes 21, 22.

In addition, in the example illustrated in FIG. 9, a matching element 73 is mounted between the power feeding line 51 and the ground electrode 60 in the lateral portion thereof. This matching element is a chip inductor or a chip capacitor, and achieves impedance matching between a coplanar line, due to the power feeding line 51 and the ground electrode 60, and the antenna. Such a matching element may not only be applied to the third embodiment but also applied to another embodiment in the same way.

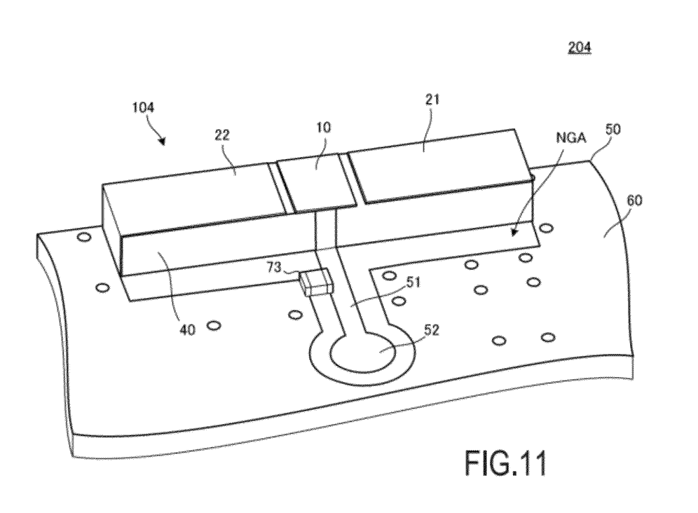

FIG. 11 is a perspective view illustrating the configuration of the main portion of an antenna 204 according to a fourth exemplary embodiment. The antenna 204 includes a circuit substrate 50 and an antenna chip 104 mounted in the circuit substrate 50.

The antenna 204 is different from the antenna 203 illustrated in FIG. 9 in the third exemplary embodiment in that, in the antenna 204, no radiation electrode is formed in the circuit substrate 50. Namely, only the antenna chip 104 covers the radiation electrode. In addition, in the example, no frequency adjusting element is provided.

While the configuration of the antenna chip 104 is basically the same as that of the antenna chip 103, the length of the dielectric block 40 is lengthened and hence, the first radiation electrode 21 and the second radiation electrode 22 are lengthened. The ground connection terminals 31 and 32 in the bottom surface of the dielectric block 40 are directly connected to the ground electrode 60.

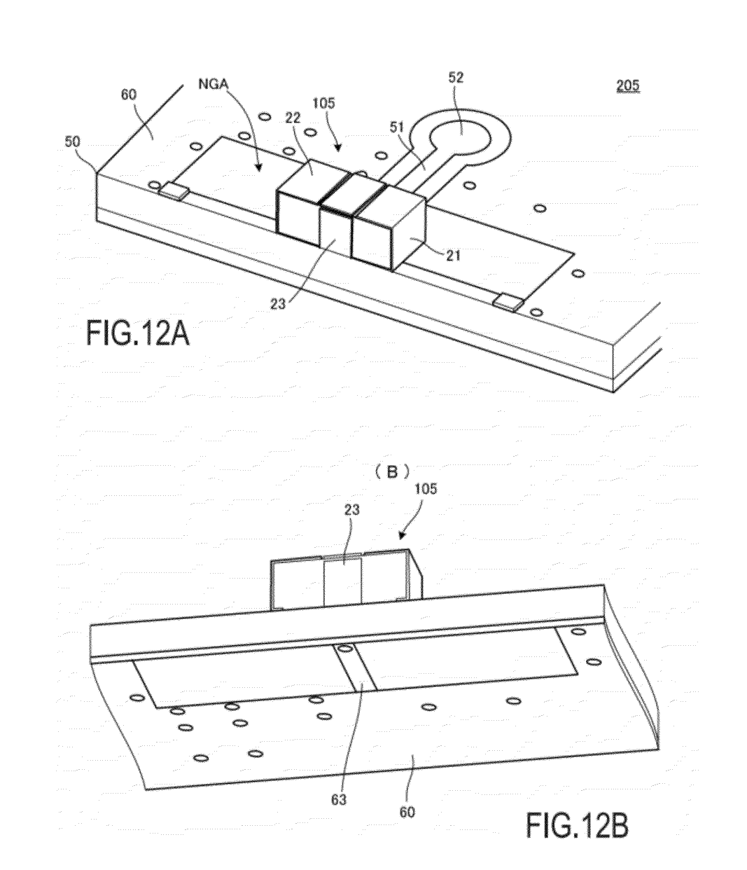

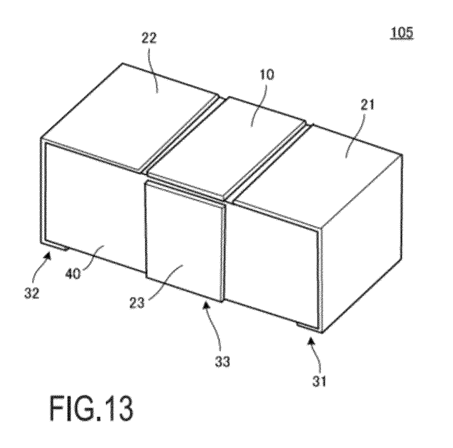

An antenna according to a fifth exemplary embodiment and a wireless communication device equipped therewith will be described with reference to FIGS. 12A, 12B, and 13.

FIG. 12A is a perspective view where the main portion of an antenna 205 is looked down (i.e., viewed) from above, and FIG. 12B is a perspective view where the main portion of the antenna 205 is looked up (i.e., viewed) from below. As illustrated in FIG. 12A and FIG. 12B, a third substrate-side radiation electrode 63 is formed in the bottom surface of a circuit substrate 50.

FIG. 13 is the perspective view of an antenna chip 105 serving as one element of the antenna 205. As illustrated in FIG. 13, in the antenna chip 105, various kinds of electrodes are formed in the outer surface of a dielectric block 40. A first radiation electrode 21 and a feeding electrode 10 are formed so that the first radiation electrode 21 and the feeding electrode 10 face each other with a predetermined gap therebetween in the top surface of the dielectric block 40. In addition, a second radiation electrode 22 is formed so that the second radiation electrode 22 and the feeding electrode 10 face each other with a predetermined gap therebetween. In the side surface of the dielectric block 40, a third radiation electrode 23 is formed so that the leading end thereof is close to the feeding electrode 10.

In the bottom surface of the dielectric block 40, ground connection terminals 31, 32, and 33 and a power feeding terminal are formed. The first radiation electrode 21 is conductively connected to the ground connection terminal 31 in the bottom surface through one end surface of the dielectric block 40. The second radiation electrode 22 is conductively connected to the ground connection terminal 32 in the bottom surface through the other end surface of the dielectric block 40. The third radiation electrode 23 is formed in one side surface of the dielectric block 40 and conductively connected to the ground connection terminal 33 in the bottom surface. In addition, the feeding electrode 10 is conductively connected to the power feeding terminal in the bottom surface through the other side surface of the dielectric block 40.

Here, one end of the third substrate-side radiation electrode 63 formed in the bottom surface of the circuit substrate 50 is connected, through a via electrode, to an electrode (electrode on the top surface side of the circuit substrate 50) to which the ground connection terminal 33 of the antenna chip 105 is connected. In addition, the other end of the third substrate-side radiation electrode 63 is connected to a ground electrode 60 on a bottom surface side.

According to the fifth exemplary embodiment, the antenna is used as a three-resonance antenna equipped with three radiation electrodes.

In embodiments consistent with the present disclosure, capacitive feeding portions located in a plurality of points can be adjusted so as to have different capacitance values, and hence, it is possible to double-resonate. In addition, the connection ends of a plurality of radiation electrodes, connected to a ground electrode, are independent of one another, and hence, it is possible to freely dispose independent lines connected from the plural radiation electrodes to the ground electrode. In addition, individual current paths are kept away from one another, and hence, it is possible to prevent the antenna efficiency from being deteriorated owing to the flow of a current of a reverse phase.

That which is claimed is:

1. A capacitive feed type antenna comprising:
plural radiation electrodes, each having a first end portion thereof connected to a ground electrode and a second end portion thereof open; and
a single feeding electrode having a first end portion thereof connected to a feeder circuit, the feeding electrode facing each of the radiation electrodes, thereby causing capacitance to occur between the feeding electrode and each of the radiation electrodes, wherein
the plural radiation electrodes and the feeding electrode are provided such that each radiation electrode is capacitively fed by the single feeding electrode, in a capacitive feeding portion in which the capacitance occurs.

2. The antenna according to claim 1, wherein
the antenna includes a circuit substrate, on which the ground electrode is formed, and a dielectric block mounted on the circuit substrate, and
at least the capacitive feeding portion among the radiation electrodes and the feeding electrode is configured in the dielectric block.

3. The antenna according to claim 2, wherein
a frequency adjusting element is mounted between at least one of the radiation electrodes and the ground electrode on the circuit substrate.

4. The antenna according to claim 1, wherein
an end portion of each of the plural radiation electrodes is disposed so as to face the feeding electrode.

5. The antenna according to claim 2, wherein
an end portion of each of the plural radiation electrodes is disposed so as to face the feeding electrode.

6. The antenna according to claim 3, wherein
an end portion of each of the plural radiation electrodes is disposed so as to face the feeding electrode.

7. The antenna according to claim 1, wherein
connection ends of the plural radiation electrodes, connected to the ground electrode, are independent from one another.

8. The antenna according to claim 2, wherein
connection ends of the plural radiation electrodes, connected to the ground electrode, are independent from one another.

9. The antenna according to claim 3, wherein
connection ends of the plural radiation electrodes, connected to the ground electrode, are independent from one another.

10. The antenna according to claim 4, wherein
connection ends of the plural radiation electrodes, connected to the ground electrode, are independent from one another.

11. The antenna according to claim 1, wherein
current paths connected from the capacitive feeding portion of the plural radiation electrodes to the ground electrode are independent from one another.

12. The antenna according to claim 2, wherein
current paths connected from the capacitive feeding portion of the plural radiation electrodes to the ground electrode are independent from one another.

13. The antenna according to claim 3, wherein
current paths connected from the capacitive feeding portion of the plural radiation electrodes to the ground electrode are independent from one another.

14. The antenna according to claim 4, wherein
current paths connected from the capacitive feeding portion of the plural radiation electrodes to the ground electrode are independent from one another.

15. The antenna according to claim 7, wherein
current paths connected from the capacitive feeding portion of the plural radiation electrodes to the ground electrode are independent from one another.

16. The antenna according to claim 11, wherein
with respect to two radiation electrodes among the plural radiation electrodes, directions of the current paths connected from the capacitive feeding portion to the ground electrode are opposite to each other.

17. The antenna according to claims 1, wherein
lengths of a first radiation electrode and a second radiation electrode from among the plural radiation electrodes are approximately equal to each other, and capacitance occurring between the first radiation electrode and the feeding electrode and capacitance occurring between the second radiation electrode and the feeding electrode are different from each other.

18. The antenna according to claim 1, wherein
from among the plural radiation electrodes, capacitance occurring between a first radiation electrode and the feeding electrode and capacitance occurring between a second radiation electrode and the feeding electrode are approximately equal to each other, and length of the first radiation electrode and the length of the second radiation electrode are different from each other.

19. A wireless communication device where the antenna according to claim 1 is provided within a chassis.
